(19) United States
(12) Patent Application Publication
(10) Pub. No.: US 2026/0337108 A1
(43) Pub. Date: Oct. 29, 2026

(54) ADHESIVE

(71) Applicant: INSAREC BV, Zulte (BE)

(72) Inventors: Dirk STANSSENS, Houthalen (BE); Rudy GALLE, Gavere (BE); Hendrik DE KEUKELEIRE, Luxembourg (LU)

(21) Appl. No.: 19/109,118

(22) PCT Filed: Sep. 15, 2023
(86) PCT No.: PCT/EP2023/075462

§ 371 Date: Mar. 5, 2025

(30) Foreign Application Priority Data
Sep. 19, 2022 (BE) 2022/5742

(51) Int. Cl. C04B 28/26; C04B 18/24; C04B 18/26; C04B 24/28; C04B 24/38

(52) U.S. Cl. CPC C04B 28/26; C04B 18/248; C04B 18/26; C04B 24/281; C04B 24/282; C04B 24/38

(57) ABSTRACT

The present invention relates to an adhesive, its method of preparation and products obtained with the aid of the adhesive. The glue contains at least a powder, water, water glass and a crosslinker. The powder contains carbohydrates and proteins. The ratio by mass of the powder to the mass of solids of the water glass is between 50:1 and 2:1.

The invention relates to an adhesive for bonding particles, fibres, layers, strands or parts, for example to produce engineered wood products, and a method of preparing this adhesive. The invention further relates to products glued with this adhesive; and a method of bonding such products with this adhesive.

In engineered wood products, an adhesive is used to connect wood particles, wood fibres, wood strands, wood layers and/or other wood parts or components. Examples of such engineered wood products are chip boards, wood fiber boards (such as MDF—Medium Density Fiberboard and HDF—High Density Fiberboard, OSB—Oriented Strand Board), and plywood boards.

It is also possible to bond cellulose fibers or cellulose products into boards. Non-limiting examples are bamboo, straw, hemp fibers or hemp strands, kenaf.

The most common adhesive used in the production of engineered wood products is an aminoplast polymer, produced via a polycondensation reaction from urea and formaldehyde to form a urea-formaldehyde resin (UF resin). Optionally, melamine is added and a melamine urea formaldehyde resin (MUF resin) is obtained, or melamine and phenol are added to form melamine urea phenol formaldehyde resins (MUPF resins). The major advantages of formaldehyde-based adhesives are their low cost—due to the use of cheap raw materials in their preparation—and their high reactivity. A disadvantage of such adhesives in engineered wood products is that they emit formaldehyde during and after polymerization. As a result, more and more people are looking to limit or even reduce formaldehyde emissions to zero. That is why formaldehyde-free adhesives for the production of engineered wood products are sought after.

US2006/0163769 describes the use of water glass as an adhesive in the production of wood engineered products that are fire resistant.

A known formaldehyde-free adhesive for use in the production of engineered wood products consists of polymeric methylene diphenyl diisocyanate (pMDI). These pMDI adhesives lead to wood products with high strength and good water resistance. However, these adhesives have a number of drawbacks. First, they are much more expensive than the aminoplasts traditionally used; this leads to a significant increase in the cost of engineered wood products. On the other hand, such adhesives have a lower stability than the classic aminoplasts, have a strong tendency to stick to process equipment—which leads, among other things, to the need for frequent cleaning of process equipment—and can lead to the release of isocyanate monomers upon application. This has a detrimental effect on the efficiency of the production process of the engineered wood products.

The pMDI adhesives have a better adhesive strength than the traditionally used aminoplasts, so that less adhesive is needed. However, this can be disadvantageous, because the smaller amount of adhesive can lead to insufficient distribution of the adhesive over the substrate.

U.S. Pat. No. 4,190,459A describes a process for producing mineral fiber mats for use as insulation material. The mineral fibers are joined together by means of a glue that is applied as a so-called emulsion of water glass and an isocyanate. It is recommended in U.S. Pat. No. 4,190,459A to use water glass with a solid content between 40 and 55% by mass. The so-called emulsions mentioned in U.S. Pat. No. 4,190,459A have an initial viscosity of 10 000 mPa·s. However, this so-called emulsion is not stable, as the viscosity increases rapidly over time.

CA2019382A1 refers in its prior art section to U.S. Pat. No. 4,190,459A and states that the emulsions described in U.S. Pat. No. 4,190,459A have limited stability. CA2019382A1 describes a mixture of isocyanate and a sufficient amount of metal soap for use as an adhesive in engineered wood products. The metal soap is used as a blocking compound to prevent reaction between water and isocyanate, therefore a sufficient amount of metal soap is needed. Furthermore, CA2019382A1 describes that water glass can also be admixed to the mixture of isocyanate and the sufficient amount of metal soap to form an emulsion.

WO2022/049513A1 describes an adhesive for engineered wood products. The glue is an emulsion of isocyanate in water. The isocyanate contains one or more of a diisocyanate, a multiisocyanate, a derivative of a diisocyanate or a derivative of a multiisocyanate. The emulsion further contains water glass. The ratio in the emulsion of the mass of the combination of water and water glass on the one hand to the mass of the isocyanate on the other is preferably between 1.2 and 6.

It is a goal of the current invention to provide an adhesive which is free of formaldehyde, which is suited to bond natural substrates; and which can be easily used as adhesive in the production of engineered wood products, such as chip boards, wood fiber boards (such as MDF-boards and HDF-boards), OSB-boards, and plywood boards.

To accomplish this goal, the invention contains different aspects.

The first aspect of the invention is an adhesive. The adhesive is characterized in that the adhesive contains at least a powder, water, water glass and a crosslinker; wherein the powder contains carbohydrates and proteins. The water glass is a combination of Na₂O and SiO₂ in water. The ratio by mass of the powder to the mass of solids of the water glass is between 50:1 and 2:1, preferably between 30:1 and 3:1.

In the context of the current invention, the terms ‘glue’ and ‘adhesive’ are synonymously used for a compound having some degree of adhesive properties, in essence the ability to provide bonding between two or more pieces of material. Likewise, the terms ‘gluing’ and ‘bonding’ are synonymously used for the act of providing bonding between two or more pieces of material.

This adhesive does not contain formaldehyde, is stable, is easy to produce and can be easily used as adhesive in the production of engineered wood products, such as chip boards, wood fiber boards (such as MDF-boards and HDF-boards), OSB-boards, and plywood boards.

The ratio by mass of the powder to the mass of solids of the water glass of the adhesive of the first aspect of the invention provides a better stability of the adhesive, giving the adhesive a good workability.

As mentioned above, water glass is a combination of Na₂O and SiO₂ in water. The (molar) ratio between SiO₂:Na₂O and the mass of solids of the water glass (in water) can vary. For example, water glass 2.0 has a SiO₂:Na₂O molar ratio of 2.0:1. Consequently, 1 gram of water glass 2.0, with a solid content of 40% by mass, contains 0.13 gram of solid Na₂O. Water glass 3.4, for example, has a SiO₂:Na₂O molar ratio of 3.4:1. Consequently, 1 gram of water glass 3.4, with a solid content of 37% by mass, contains 0.084 grams of solid Na₂O. Solid sodium silicate typically has a high Na₂O content, which dissolved in water corresponds to water glass 1.0 to 1.5, or in other words a SiO₂:Na₂O molar ratio of 1.0:1 to 1.5:1.

In the context of the present invention, “solid content” refers to the percentage by mass of the solids, unless stated otherwise.

A preferred embodiment of the first aspect of the invention is characterized in that the ratio by mass of the powder to the mass of solid Na₂O of the water glass is between 140:1 and 6:1, preferably between 80:1 and 10:1, more preferably from 60:1 and 15:1.

The ratio of the mass of the powder to the mass of solid Na₂O of the water glass according to this embodiment of the invention also ensures good water resistance of engineered wood products bonded with this adhesive.

In the first aspect of the invention, the powder is preferably mainly composed of proteins and carbohydrates. The powder may still contain a certain amount of water, even if the powder itself feels dry.

Typically, the powder has only limited solubility in water. As a result, suspensions can be obtained with a sufficiently low viscosity and a sufficiently high solid content. An adhesive with a low viscosity can be sufficiently distributed over the substrate, for example by spraying or nebulizing the adhesive. In principle, an adhesive could always have a sufficiently low viscosity by adding sufficient water, but an excess of water leads to too high a pressure build-up when pressing the glued substrates, which can cause cracks in the cured substrate.

The use of carbohydrates (such as starch) and proteins as an adhesive are each known separately. Before the development of formaldehyde-based adhesives, proteins such as gelatin were often used as glue. Starch is also often used as an adhesive in, for example, the paper industry, where different layers of paper are glued together. However, the starch is first boiled up so that the crystalline phase of the starch is broken and the adhesive power of the starch increases. In all these cases, adhesives with a low solid content and a high viscosity are obtained.

The aim of the invention is precisely to make an adhesive of which the carbohydrates present have retained their crystalline structure. Furthermore, the proteins present in the powder ensure a further insolubility of the powder in water at temperatures below 50 °C.

At higher temperatures, preferably above 60 °C, the crystalline structure of the carbohydrate can be broken and the affinity of the powder for water increases, with a significant increase in viscosity.

The adhesive can be produced by initially placing the powder in an aqueous suspension, preferably by high shear or turbulence. Because the powder has a limited solubility in water due to its composition, a suspension with a high solid content can be obtained, while the viscosity remains limited. As mentioned earlier, a low viscosity is important to be able to sufficiently distribute the resulting adhesive over the substrate, for example by spraying the adhesive.

In a next phase of producing the adhesive according to the invention, the water glass can be added to the aqueous suspension of the powder. The water glass interacts with the powder. This results in a moderate increase of viscosity and an activation of the powder. This activation also ensures that the dispersing capacity of the powder is increased and that the addition of a crosslinker at a later stage leads to a homogeneous and stable suspension.

In a next process step, a crosslinker, which is capable of reacting with both the substrate and the powder, can be added to the aqueous suspension of the powder and the waterglass. Preferably, crosslinkers are used which contain isocyanate, epoxy, azetidinium and/or cyclic anhydride groups.

It is an important advantage of the invention that a stable suspension of the crosslinker (e.g. isocyanate) in water is obtained. The combination of the powder and the water glass thereby acts as a dispersant for the crosslinker.

Addition of the water glass provides for an increased adhesive strength of the powder. After applying the adhesive, pressure is applied at elevated temperature. At this elevated temperature, the proteins of the powder are denatured and the carbohydrates lose their crystallinity. Functional groups are also released at this elevated temperature, mainly on the proteins, as a result of which the water glass connected to the powder undergoes a hardening reaction. These functional groups are therefore latent at low temperatures and are only expressed when the adhesive is heated to temperatures above 50 °C.

Since the cheap water glass will also contribute to the adhesive strength, the amount of the expensive crosslinker can remain limited. The amount of water glass is therefore preferably chosen such that the water glass is not only active as a dispersant, but also to a significant extent as an adhesive component. This allows to use less crosslinker, and therefore to obtain a cheaper adhesive (and cheaper engineered wood products produced with this adhesive), that can be well dosed and uniformly distributed.

It is an important advantage of the invention that the crosslinker does not merely act as a chain extender of the powder, but that it is also capable of reacting with the hydroxyl groups of the substrate (e.g. wood) to improve adhesive strength.

The water glass can moreover lead to an improvement of the reactivity of hydroxyl groups of wood on the one hand, and the crosslinker (e.g. isocyanate) on the other hand. The water glass is thus not only active as an emulsifier for the crosslinker (e.g. isocyanate). When using the adhesive and while elevating the temperature and after evaporation of the water, the suspension is broken, and the water glass can act as a catalyst for the reaction of the crosslinker (e.g. isocyanate) with the hydroxyl groups of wood.

A preferred embodiment of the first aspect of the invention is characterized in that the powder containing carbohydrates and proteins is obtained by grinding a vegetable raw material, such as cereals (for example, wheat, rye, barley, millet, rice or oats), maize, beets, nuts (for example, palm nuts or coconuts), seeds (for example, rapeseed, linseed or sunflower seeds) or legumes (for example, soybeans, peas, beans, faba beans); or is a combination of two or more of these.

These are readily available raw materials from which the powder can be extracted. It is also an important advantage that different raw materials can be used. Production of the adhesive according to the invention is therefore not bound to one specific raw material.

A more preferred embodiment of the first aspect of the invention is characterized in that the powder is obtained by grinding pulse beans, such as soybeans, peas, beans, faba beans.

A preferred embodiment of the first aspect of the invention is characterized in that the powder is starch and/or flour; such as cereal starch and/or flour (for example, wheat, rye, barley, millet, rice or oats), low-grade flour, maize starch and/or flour, beet starch and/or flour, nut starch and/or flour (for example, palm nuts or coconuts), seed starch and/or flour (for example, from rapeseed, linseed or sunflower seeds) or legume starch and/or flour (for example, from soybeans, peas, beans, faba beans); or is a combination of two or more of these.

As generally known, the terms “starch” and “flour” are interchangeably used for a powder obtained from grinding a vegetable raw material A more preferred embodiment of the first aspect of the invention is characterized in that the powder is pulse bean starch and/or flour, such as soybean flour, pea starch, faba bean starch, or a combination of two or more of these.

Flour and starch are readily available. It is also an important advantage that different types of flour and/or starch can be used. Production of the adhesive according to the invention is therefore not bound to one specific raw material or flour and/or starch type.

A particularly interesting kind of flour for use in the invention is the so-called ‘low-grade flour’, which is a residual material of the wheat flour production. Due to the browner color of the low-grade flour, this product is declared unsuitable for the production of wheat bread and is processed as animal feed. Low-grade flour has a higher ratio of proteins to carbohydrates compared to the grain from which it is obtained. Without willing to be bound to any theory, the inventors suspect that the higher ratio of proteins to carbohydrates may lead to better adhesive properties.

A preferred embodiment of the first aspect of the invention is characterized in that the powder in water is obtained by a process in which a fermentation is performed on a vegetable raw material.

This allows to prepare the powder from residual flows from the agricultural industry and thus improves the valorisation of these residual flows. In such fermentation processes, microorganisms such as fungi or bacteria convert natural raw materials into powders in aqueous suspension. These powders have a homogeneous combination of carbohydrates and proteins.

A preferred embodiment of the first aspect of the invention is characterized in that, in the powder, the ratio by mass of the proteins to the mass of the carbohydrates is between 2:1 and 1:30; preferably between 1.5:1 and 1:15, more preferably between 1:2 and 1:10.

A preferred embodiment of the first aspect of the invention is characterized in that the viscosity of the adhesive at 25 °C is less than 1000 mPa·s, preferably less than 500 mPa·s.

An adhesive with such viscosity values ensures a good distribution of the adhesive over the products to be bonded. Due to its low viscosity, the adhesive can also be applied by spraying. These viscosity values also ensure good penetration of the adhesive into the pores of the products to be bonded. Due to the low viscosity, the workability of the adhesive is therefore better.

A preferred embodiment of the first aspect of the invention is characterized in that the powder, the water, the water glass and the crosslinker are homogeneously distributed in the adhesive.

This embodiment has the advantage that the adhesive can be used as a one-component system. The adhesive can be stored and is easily usable without further limitation.

A preferred embodiment of the first aspect of the invention is characterized in that the adhesive is a two-component adhesive; with a first component and a second component.

Wherein the first component differs from the second component in the presence of the powder and the crosslinker, respectively.

The first component can contain no waterglass, or a part of the water glass or the total amount of the water glass. If the first component contains a part of the water glass or the total amount of the water glass, this promotes dispersing the powder.

The second component can contain no waterglass, or a part of the water glass or the total amount of the water glass. If the second component contains a part of the water glass or the total amount of the water glass, this promotes emulsification of the crosslinker in the second component.

In the case of the two-component adhesive, both components can be stored separately, and mixed when the adhesive is needed; or separately applied to the to-be-glued products. Separate storage of both components of the (two-component) adhesive provides for a prolonged shelf life of the adhesive.

A preferred embodiment of the first aspect of the invention is characterized in that the solid content in the adhesive is between 10 and 40% by mass, preferably between 15 and 35% by mass.

The adhesive according to this embodiment is easy to process, without too much water having to be transported when transporting the glue.

A preferred embodiment of the first aspect of the invention is characterized in that the crosslinker is a product containing a least two isocyanate groups, preferably wherein the crosslinker contains one or more of a diisocyanate, a multiisocyanate, a derivative of a diisocyanate or a derivative of a multiisocyanate.

Such crosslinkers are readily available. Moreover, a limited amount of such crosslinker is sufficient.

A preferred embodiment of the first aspect of the invention is characterized in that the crosslinker is a derivative or a polymer of methylene diphenyl diisocyanate (MDI), preferably a polymeric methylene diphenyl diisocyanate (pMDI).

Such crosslinkers are also readily available, and again a limited amount of such crosslinker suffices.

In principle, multiple types of isocyanates can be used in the invention. However, polymeric methylene diphenyl diisocyanate (pMDI) is preferred. Unlike many other isocyanates, polymeric methylene diphenyl diisocyanate (pMDI) has little to no compatibility with water. In many types of isocyanates, water reacts with the isocyanate groups, resulting in the release of carbon dioxide. Since polymeric methylene diphenyl diisocyanate (pMDI) and water show little or no compatibility, there is only a limited reaction when water and polymeric methylene diphenyl diisocyanate (pMDI) come into contact. This is a result from the fact that when water and polymeric methylene diphenyl diisocyanate (pMDI) are mixed and the mixing is stopped, the water and the polymeric methylene diphenyl diisocyanate (pMDI) separate from each other. The use of the water glass and the powder according to the invention however stabilizes the suspension.

Moreover, the polymeric methylene diphenyl diisocyanate (pMDI) has a large number of reactive groups per molecule. This is advantageous for the adhesive strength since a dense network of crosslinking is obtained. Polymeric methylene diphenyl diisocyanate (pMDI) is moreover the cheapest option of the commercially available isocyanates.

Because of these aspects, polymeric methylene diphenyl diisocyanate (pMDI) allows to obtain the advantages of the suspension according to the invention in the most optimal way, with a low cost of the adhesive and the products bonded with the adhesive.

A preferred embodiment of the first aspect of the invention is characterized in that the crosslinker is a product containing at least two epoxy groups, or at least two cyclic anhydride groups, or at least two azetidine functional groups; or mixtures of two or more of these products.

These crosslinkers are products containing functional groups that are highly reactive with hydroxyl and/or carboxyl groups.

Examples of crosslinkers that contain at least two epoxy groups, and that can therefore be used in the invention, are bisphenol A (BPA) diepoxide, glycidyl cyclohexene oxide, epoxidized soybean or linseed oil, multi-functional glycidyl ethers or esters. Examples of azetidinium-containing crosslinkers are those used in the paper industry to make the paper stronger, mainly under wet conditions, for example Kymene 557H. Examples of cyclic anhydride-containing crosslinkers are maleinized oils such as those from soybean or linseed oil.

It is an advantage that different types of crosslinkers can be used. The invention is not limited to the use of one type of crosslinker.

A preferred embodiment of the first aspect of the invention is characterized in that the ratio by mass of the crosslinker to the mass of the powder is between 1:15 and 2:1, preferably between 1:10 and 1:1, more preferably between 1:8 and 1:1.25, even more preferably between 1:2.5 and 1:1.5.

The amount of crosslinker used in the adhesive can therefore be limited. This lowers the price of the adhesive, since the crosslinker represents the most expensive in the adhesive.

A preferred embodiment of the first aspect of the invention is characterized in that the adhesive contains a thermoplastic adhesive component, preferably a biorenewable thermoplastic adhesive component, such as an aqueous dispersion of polylactic acid or a natural latex.

The adhesive can be tailored for specific applications. The use of a thermoplastic adhesive component allows to reduce the amount of crosslinker. Furthermore, the use of a biologically renewable thermoplastic adhesive component ensures the “natural” character of the adhesive.

A preferred embodiment of the first aspect of the invention is characterized in that the molar ratio of SiO₂ to Na₂O in the waterglass is between 4 and 1.5, preferably between 3.8 and 2.0, more preferably between 3.5 and 2.5, even more preferably between 3.5 and 2.8.

It appeared that use of the adhesive according to this embodiment results in a higher water fastness of the bonded product. A relatively small amount of Na₂O, relative to the amount of SiO₂, in the water glass, seems to accomplish this feature.

A preferred embodiment of the first aspect of the invention is characterized in that the adhesive contains one or more of water repellent additives, catalysts, dyes, pigments, flame retardants, cold tack improvers, or blowing agents.

The adhesive may contain such additives to give the glued products specific properties and/or to improve the processability of the glue. Examples of water repellents that can be used are wax emulsions (e.g. based on paraffin or hydrogenated vegetable oils), alkene-ketene dimers, and alkyl succinic anhydride. Preferably, these water-repellent agents are added as an emulsion. Examples of catalysts to accelerate and improve the reaction between the hydroxyl groups of wood and an isocyanate crosslinker (e.g. pMDI) are tertiary amines and derivatives of tin; these products are well known in the polyurethane industry.

A preferred embodiment of the first aspect of the invention is characterized in that the D₅₀ value of the particle size distribution by volume of the powder, measured in aqueous dispersion by laser diffraction (Beckman Coulter laser diffraction device LS 13 320), is less than 200 micrometer, preferably less than 100 micrometer, more preferably less than 50 micrometer, even more preferably less than 30 micrometer. The D₅₀ value is the particle size—expressed in microns—wherein 50% of the particles are smaller than this value.

These embodiments provide better adhesive stability and good adhesive efficiency.

A preferred embodiment of the first aspect of the invention is characterized in that the D₉₀ value of the particle size distribution by volume of the powder, measured in aqueous dispersion by laser diffraction, is less than 200 micrometer, preferably less than 100 micrometer. The D₉₀ value is the particle size—expressed in microns—wherein 90% of the particles are smaller than this value.

In a further aspect, the invention provides a method of preparing the adhesive as described herein, the method comprising the steps of:
mixing a powder and water to obtain a first aqueous suspension;
adding water glass and a crosslinker to the first aqueous suspension; and
further mixing the resulting suspension to obtain the adhesive;
   wherein the powder contains carbohydrates and proteins; wherein the water glass contains a combination of Na₂O and SiO₂; and wherein the ratio by mass of the powder to the mass of solids of the water glass is between 50:1 and 2:1, preferably between 30:1 and 3:1.

A preferred embodiment of the method of preparing the adhesive of the invention is characterized in that the powder and water are mixed by high shear or turbulence.

A preferred embodiment of the method of preparing the adhesive of the invention is characterized in that the water glass is added first to, and mixed with, the first aqueous suspension, before the crosslinker is added.

As mentioned hereinbefore, the affinity of the powder may increase at elevated temperatures, such as at 60 °C or more, resulting in an increase of viscosity. To avoid or minimize the increase of viscosity, it may be preferred to maintain the temperature during the steps of the method below 60 °C, such as below 50 °C, below 40 °C, and even below 30 °C. The temperature may be maintained by any suitable means known in the art, such as cooling devices.

A preferred embodiment of the method of preparing the adhesive of the invention is characterized in that the temperature during preparation of the first aqueous suspension and/or the adhesive is maintained below 60 °C, preferably below 50 °C, more preferably below 40 °C, even more preferably below 30 °C.

It may be beneficial for the adhesive strength of the adhesive, if the adhesive is applied on or mixed with the substrate shortly after the crosslinker has been added to the powder, the water glass, and the water, such as within 1 hour, within 50 min, within 40 min, within 30 min, even within 10 min after adding the crosslinker to the other components of the adhesive. By using the adhesive shortly after the crosslinker has been added to the powder, the water glass, and the water, less of the crosslinker may have reacted with the powder, and consequently more of the crosslinker may still be available to react with the hydroxyl groups of the substrate (e.g. wood).

In yet a further aspect, the invention provides an adhesive prepared according to the method as defined herein.

In a yet a further aspect, the invention provides a product. The product contains particles, fibres, layers, strands or parts; wherein the particles, fibres, layers, strands or parts are glued together with an adhesive according to any one of embodiments of the first aspect of the invention, in a pressing process at elevated temperature in which water is evaporated from the adhesive and the adhesive provides bonding of the particles, fibres, layers, strands or parts. In the product, the ratio by mass of the total amount of particles, fibres, layers, strands or parts to the solid content of the adhesive, is between 99:1 and 92:8, preferably between 98:2 and 95:5.

A preferred embodiment of the product of the invention is characterized in that the ratio by mass of solids of the crosslinker in the adhesive to the total amount of particles, fibres, layers, strands of the product is between 0.5 and 2% by mass, preferably between 0.75 and 1.75% by mass, more preferably between 1 and 1.5% by mass.

As mentioned previously, the cheap water glass contributes to the adhesive strength, which allows using a smaller amount of the expensive crosslinker in the adhesive, relative to the total amount of particles, fibres, layers, strands in the product.

The adhesive does not contain formaldehyde. The bonding can be achieved with a small quantity of the adhesive.

Preferably, the product is a board, for example a wood fiber board (for example an MDF board or an HDF board), a chipboard, an OSB (Oriented Strand Board) board or a plywood board. The product may also be a pressed molded part wherein the glued wood parts are pressed in a mold into the desired shape, for example for making pallet blocks.

In a preferred embodiment of the invention, the particles, fibres, layers, strands or parts are wood based or cellulose based, such as bamboo, straw, reed, hemp, palm, miscanthus, bagasse, molasses or agricultural waste streams.

It appeared that the adhesive is particularly suited for gluing together wood components, such as wood chips, wood strands or wood fibres.

The final aspect of the invention relates to a method of preparing a product. The method contains the steps:
providing a quantity of particles, fibres, layers, strands or parts;
applying an adhesive according to any one of the embodiments of the first aspect of the invention to the particles, fibres, layers, strands or parts;
putting the mixture of the particles, fibres, layers, strands or parts and the adhesive into a shape, for example in the form of a board;
curing the adhesive at elevated temperature and under pressure, wherein water evaporates from the adhesive, and wherein the curing of the adhesive results in a product in which the particles, fibres, layers, strands or parts are bound together by the adhesive.

In principle, the products are obtained by pressing the glued wood parts with heated press plates, but for thicker products or molded parts, additional heating can be used via the injection of steam.

The glue does not contain formaldehyde and can be easily used in the method.

Preferably, the particles, fibres, layers, strands or parts are wood based or cellulose based, such as bamboo, straw, reed, hemp, palm, miscanthus, bagasse, molasses or agricultural waste streams.

It appeared that the adhesive is particularly suited for gluing together wood components, such as wood chips, wood strands or wood fibres.

A preferred embodiment of the method of preparing the product of the invention is characterized in that, in the product, the ratio by mass of the total amount of particles, fibres, layers, strands or parts to the solid content of the adhesive, is between 99:1 and 92:8, preferably between 98:2 and 95:5.

It is therefore possible to work with a limited amount of adhesive, relative to the mass of the components to be glued together.

A preferred embodiment of the method of preparing the product of the invention is characterized in that the product is a board, for example a wood fiber board (for example an MDF board or an HDF board), a chipboard, an OSB (Oriented Strand Board) board or a plywood board.

The adhesive is particularly suitable for such products. The obtained boards have good mechanical properties; and are also resistant to water.

As mentioned hereinbefore, it may be beneficial for the adhesive strength of the adhesive, and consequently of the tensile strength of the glued product, if the adhesive is applied on or mixed with the substrate shortly after the crosslinker has been added to the powder, the water glass, and the water.

A preferred embodiment of the method of preparing the product of the invention is characterized in that the adhesive is applied to the particles, fibres, layers, strands or parts within 1 hour after the crosslinker has been added to the powder, the water glass, and the water, preferably within 50 min, more preferably within 40 min, even more preferably within 30 min.

### Materials Used

| | | | Mass ratio | | |
|---|---|---|---|---|---|
| | | | protein: | | |
| Powder | Type | Source | carbohydrate | D₅₀ | D₉₀ |
| Rye Flour (RF) | Snip | Dossche | 12:88 | — | — |
| Low-grade flour 1 | — | Belgium | 15:85 | 83.2 | 249 |
| Low-grade flour 2 | — | | 15:85 | 28 | 92 |
| Pea Starch (PS) | E1370D | Vestkorn, | 15:85 | 29.8 | 67.4 |
| Pea Starch (PS) | F70D | Denmark | 15:85 | — | — |
| Faba bean starch | — | | 22:78 | 28.4 | 87.9 |
| (FS) | | | | | |

Water glass 2.0 with a solid content of 40% by mass was obtained from PQ Chemicals and has a SiO₂:Na₂O molar ratio of 2.0:1. Water glass 3.4 with a solid content of 37% by mass was also obtained from PQ Chemicals and has a SiO₂:Na₂O molar ratio of 3.4:1. I-Bond PB PM 4350 (pMDI) was obtained from Huntsman. A 40% wax emulsion Vivastar 9061 was obtained from H&R, the Netherlands.

### EXAMPLES

### Example 1

In a first example according to the invention, a suspension is obtained by mixing under high shear 10 grams of rye flour (with a solid content of 90% by mass) with 60 grams of water. Then 2.5 grams of water glass 2.0 (with a solid content of 40% by mass), which corresponds to 0.33 grams of Na₂O solids, and 5.5 grams of pMDI are added to the suspension and mixed. The resulting adhesive (suspension) has good physical stability, and the viscosity is 150 mPa·s (measured at 25 °C). 7.5 grams of Vivastar 9061 is first added to 450 grams of wood chips and mixed, and subsequently the suspension as described above is added and mixed. After the entire mixture has been mixed for 2 minutes, the glued chips are placed in a molded part and the resulting mat is pressed at 200 °C for 2 minutes to form a board with a thickness of 13 mm and a density of 680 kg/m³. The internal tensile strength of the sheet was 0.50 N/mm² and the degree of swelling after immersion in water for 2 hours was 10%.

### Example 2

In a second example according to the invention, the glued chips as described in example 1 are first stored at 25 °C for 30 min and then pressed according to the same conditions as example 1. The measured tensile strength was 0.48 N/mm² and the degree of swelling after immersion in water for 2 hours was 11%.

### Example 3

In a third example according to the invention, the procedure of example 1 is repeated, but with 10 grams of pea starch E1370D instead of rye flour. The resulting adhesive (suspension) has good physical stability, and the viscosity is 130 mPa·s (measured at 25 °C).

The measured tensile strength and the degree of swelling were 0.52 N/mm² and 6%, respectively, for a board with a density of 700 kg/m³ and a thickness of 12 mm.

The D₅₀ value of the particle size distribution by volume measured in aqueous dispersion by laser diffraction, of the powder used in the third example is 29.8 micrometers. The D₉₀ value of the particle size distribution by volume, measured in aqueous dispersion by laser diffraction, of the powder used in the third example is 67.4 micrometers.

### Example 4

In a fourth example according to the invention, the procedure of example 1 is repeated, but with 10 grams of pea starch F70D instead of rye flour; and 80 grams of water instead of 60 grams. The resulting adhesive (suspension) has good physical stability, and the viscosity is 400 mPa·s (measured at 25 °C). The measured tensile strength and the degree of swelling were 0.58 N/mm² and 6%, respectively, for a board with a density of 680 kg/m³ and a thickness of 13 mm.

### Comparative Example 5

In comparative example 5, the procedure of example 1 is repeated, but without adding water glass. The resulting suspension has poor physical stability. After a few minutes, pMDI drops become visible in the suspension, indicating phase separation. The measured tensile strength and the degree of swelling were 0.15 N/mm² and 20%, respectively, for a board with a density of 680 kg/m³ and a thickness of 13 mm.

### Example 6

In a sixth example according to the invention, the procedure of example 1 is repeated, but a first component of the adhesive is obtained by mixing under high shear 10 grams of rye flour (with a solid content of 90%) with 35 grams of water. A second component of the adhesive is separately obtained by mixing 25 grams of water, 2.5 grams of water glass 2.0 and 5.5 grams pMDI under high shear to provide an emulsion.

After adding the wax emulsion to the wood chips in accordance with example 1, the first component and the second component are dosed separately onto the wood chips and mixed well for 2 minutes. The measured tensile strength and degree of swelling of the chipboard obtained were 0.45 N/mm² and 14%, respectively, for a board with a density of 710 kg/m³ and a thickness of 12 mm.

### Example 7

In a seventh example according to the invention, the procedure of example 1 is repeated, but a suspension is obtained by mixing under high shear 10 grams of faba bean starch with 60 grams of water. Then 4.0 grams of water glass 3.4 (with a solid content of 37% by mass), which corresponds to 0.34 grams of Na₂O solids, and 4.5 grams of pMDI are added to the suspension and mixed. The resulting adhesive (suspension) has good physical stability, and the viscosity is 160 mPa·s (measured at 25 °C).

The measured tensile strength and degree of swelling of the chipboard obtained were 0.46 N/mm² and 7%, respectively, for a board with a density of 610 kg/m³ and a thickness of 12 mm.

The D₅₀ value of the particle size distribution by volume, measured in aqueous dispersion by laser diffraction, of the powder used in the seventh example is 28.4 micrometers. The D₉₀ value of the particle size distribution by volume, measured in aqueous dispersion by laser diffraction, of the powder used in the seventh example is 87.9 micrometers.

### Example 8

In an eighth example according to the invention, the procedure of example 1 is repeated, but with 6 grams of water glass 2.0 (with a solid content of 40%), which corresponds to 0.79 grams of Na₂O solids, and 4.5 grams of pMDI. The resulting adhesive (suspension) has good physical stability, and the viscosity is 140 mPa·s (measured at 25 °C). The measured tensile strength and the degree of swelling were 0.45 N/mm² and 15%, respectively, for a board with a density of 680 kg/m³ and a thickness of 12 mm.

### Example 9-10

In a ninth and tenth example according to the invention, the procedure of example 1 is repeated, but with low-grade flour having a different particle size as powder.

For this purpose, 10 grams of low-grade flour (1 or 2) are suspended in 60 grams of water and then 4.0 grams of water glass 3.4 and 4.5 grams of pMDI are added. Both mixtures have good physical stability.

10 grams of Vivastar 9061 is first added to 450 grams of wood chips and mixed, and subsequently the suspension as described above is added and mixed. The glued chips are pressed at 200 °C for 2 minutes. The obtained chip boards with a thickness of 13 mm both show a degree of swelling of 6% after immersion in water for 2 hours. The tensile strength of the chip board with Low-grade flour 1 is 0.38 N/mm², while the tensile strength of the chip board with Low-grade flour 2 is 0.58 N/mm². Both boards have a density of 615 kg/m³.

The tables below give an overview of the adhesives according to the different examples, a number of parameters of the composition and the viscosity of the adhesives, as well as the tensile strength and swelling of the products made with the adhesives.

### Overview Examples

| | | | Mass | Mass ratio | | |
|---|---|---|---|---|---|---|
| | | | solids | powder/ | | Ratio |
| | Powder/ | Mass | water | water | Mass | powder/ |
| Ex | Type | powder | glass | glass | Na₂O | Na₂O |
| 1 | RF | 9 | 1 | 9:1 | 0.33 | 27:1 |
| 2 | RF | 9 | 1 | 9:1 | 0.33 | 27:1 |
| 3 | PS E1370D | 10 | 1 | 10:1 | 0.33 | 30:1 |
| 4 | PS F70D | 10 | 1 | 10:1 | 0.33 | 30:1 |
| 5 | RF | 9 | 0 | — | — | — |
| 6 | RF | 9 | 1 | 9:1 | 0.33 | 30:1 |
| 7 | FS | 10 | 1.48 | 7:1 | 0.34 | 30:1 |
| 8 | RF | 9 | 2.4 | 4:1 | 0.79 | 13:1 |
| 9 | Low-grade | 10 | 1.48 | 7:1 | 0.34 | 30:1 |
| | flour 1 | | | | | |
| 10 | Low-grade | 10 | 1.48 | 7:1 | 0.34 | 30:1 |
| | flour 2 | | | | | |

| | | | 1 C | | Tensile | |
|---|---|---|---|---|---|---|
| | Powder/ | Mass ratio | vs | Visco | strength | Swelling |
| Ex | Type | protein:carbohydrate | 2 C | (mPa · s) | (N/mm²) | (%) |
| 1 | RF | 12:88 | 1 C | 150 | 0.50 | 10 |
| 2 | RF | 12:88 | 1 C | 150 | 0.48 | 11 |
| 3 | PS E1370D | 15:85 | 1 C | 130 | 0.52 | 6 |
| 4 | PS F70D | 15:85 | 1 C | 400 | 0.58 | 6 |
| 5 | RF | 12:88 | 1 C | 120 | 0.15 | 20 |
| 6 | RF | 12:88 | 2 C | — | 0.45 | 14 |
| 7 | FS | 22:78 | 1 C | 160 | 0.46 | 7 |
| 8 | RF | 12:88 | 1 C | 140 | 0.45 | 15 |
| 9 | Low-grade | 15:85 | 1 C | — | 0.38 | 6 |
| | flour 1 | | | | | |
| 10 | Low-grade | 15:85 | 1 C | — | 0.58 | 6 |
| | flour 2 | | | | | |

1. Adhesive, characterized in that the adhesive contains at least a powder, water, water glass and a crosslinker; wherein the powder contains carbohydrates and proteins;
wherein the water glass contains a combination of Na₂O and SiO₂;
wherein the ratio by mass of the powder to the mass of solids of the water glass is between 50:1 and 2:1, preferably between 30:1 and 3:1.

2. Adhesive according to claim 1, characterized in that the ratio by mass of the powder to the mass of solid Na₂O of the water glass is between 140:1 and 6:1, preferably between 80:1 and 10:1, more preferably from 60:1 and 15:1.

3. Adhesive according to any one of the preceding claims, characterized in that the powder is obtained by grinding a vegetable raw material, such as cereals (for example, wheat, rye, barley, millet, rice or oats), maize, beets, nuts (for example, palm nuts or coconuts), seeds (for example, rapeseed, linseed or sunflower seeds) or legumes (for example, soybeans, peas, beans, faba beans); or is a combination of two or more of these.

4. Adhesive according to any one of the preceding claims, characterized in that the powder is flour; such as cereal flour (for example, wheat, rye, barley, millet, rice or oats), low-grade flour, maize flour, beet flour, nut flour (for example, palm nuts or coconuts), seed flour (for example, from rapeseed, linseed or sunflower seeds) or legume flour (for example, from soybeans, peas, beans, faba beans); or is a combination of two or more of these.

5. Adhesive according to any one of the preceding claims, characterized in that the powder in water is obtained by a process in which a fermentation is performed on a vegetable raw material.

6. Adhesive according to any one of the preceding claims, characterized in that, in the powder, the ratio by mass of the proteins to the mass of the carbohydrates is between 2:1 and 1:30; preferably between 1.5:1 and 1:15, more preferably between 1:2 and 1:10.

7. Adhesive according to any one of the preceding claims, characterized in that the viscosity of the adhesive at 25 °C is less than 1000 mPa·s, preferably less than 500 mPa·s.

8. Adhesive according to any one of the preceding claims, characterized in that the powder, the water, the water glass and the crosslinker are homogeneously distributed in the adhesive.

9. Adhesive according to any one of the preceding claims 1-7, characterized in that the adhesive is a two-component adhesive; with a first component and a second component;
wherein the first component contains the powder, a part of the water, and the total amount of the water glass or a part of the water glass or none of the water glass;
wherein the second component contains the crosslinker, a part of the water, and the total amount of the water glass or a part of the water glass or none of the water glass.

10. Adhesive according to any one of the preceding claims, characterized in that the solid content in the adhesive is between 10 and 40% by mass, preferably between 15 and 35% by mass.

11. Adhesive according to any one of the preceding claims, characterized in that the crosslinker is a product containing a least two isocyanate groups, preferably wherein the crosslinker contains one or more of a diisocyanate, a multiisocyanate, a derivative of a diisocyanate or a derivative of a multiisocyanate.

12. Adhesive according to any one of the preceding claims, characterized in that the crosslinker is a derivative or a polymer of methylene diphenyl diisocyanate (MDI), preferably a polymeric methylene diphenyl diisocyanate (pMDI).

13. Adhesive according to any one of the preceding claims, characterized in that the crosslinker is a product containing at least two epoxy groups, or at least two cyclic anhydride groups, or at least two azetidine functional groups; or mixtures of two or more of these products.

14. Adhesive according to any one of the preceding claims, characterized in that the ratio by mass of the crosslinker to the mass of the powder is between 1:15 and 2:1, preferably between 1:10 and 1:1, more preferably between 1:8 and 1:1.25, even more preferably between 1:2.5 and 1:1.5.

15. Adhesive according to any one of the preceding claims, characterized in that the adhesive contains a thermoplastic adhesive component, preferably a biorenewable thermoplastic adhesive component, such as an aqueous dispersion of polylactic acid or a natural latex.

16. Adhesive according to any one of the preceding claims, characterized in that the molar ratio of SiO₂ to Na₂O in the waterglass is between 4 and 1.5, preferably between 3.8 and 2.0, more preferably between 3.5 and 2.5, even more preferably between 3.5 and 2.8.

17. Adhesive according to any one of the preceding claims, characterized in that the adhesive contains one or more of water repellent additives, catalysts, dyes, pigments, flame retardants, cold tack improvers, or blowing agents.

18. Adhesive according to any one of the preceding claims, characterized in that the adhesive is liquid and the powder is in suspension in the adhesive.

19. Adhesive according to any one of the preceding claims, characterized in that the D₅₀ value of the particle size distribution by volume of the powder, measured in aqueous dispersion by laser diffraction, is less than 200 micrometer, preferably less than 100 micrometer, more preferably less than 50 micrometer, even more preferably less than 30 micrometer.

20. Adhesive according to any one of the preceding claims, characterized in that the D₉₀ value of the particle size distribution by volume of the powder, measured in aqueous dispersion by laser diffraction, is less than 200 micrometer, preferably less than 100 micrometer.

21. Product, wherein the product contains particles, fibres, layers, strands or parts; wherein the particles, fibres, layers, strands or parts are glued together with an adhesive according to any one of the preceding claims, in a pressing process at elevated temperature in which water is evaporated from the adhesive and the adhesive provides bonding of the particles, fibres, layers, strands or parts;
wherein, in the product, the ratio by mass of the total amount of particles, fibres, layers, strands or parts to the solid content of the adhesive, is between 99:1 and 92:8, preferably between 98:2 and 95:5.

22. Product according to claim 21, wherein the ratio by mass of solids of the crosslinker in the adhesive to the total amount of particles, fibres, layers, strands of the product is between 0.5 and 2% by mass, preferably between 0.75 and 1.75% by mass, more preferably between 1 and 1.5% by mass.

23. Product according to any one of the preceding claims 21-22, characterized in that the product is a board, for example a wood fiber board (for example an MDF board or an HDF board), a chipboard, an OSB (Oriented Strand Board) board or a plywood board.

24. Product according to any one of the preceding claims 21-22, characterized in that the products is a pressed molded part, for example a pallet block.

25. Product according to any one of the preceding claims 21-24, characterized in that the particles, fibres, layers, strands or parts are wood based or cellulose based, such as bamboo, straw, reed, hemp, palm, miscanthus, bagasse, molasses or agricultural waste streams.

26. Method for preparing a product, wherein the method comprises the steps of
providing a quantity of particles, fibres, layers, strands or parts;
applying an adhesive, according to any one of the preceding claims 1-20, to the particles, fibres, layers, strands or parts;
putting the mixture of the particles, fibres, layers, strands or parts and the adhesive into a shape, for example in the form of a board;
curing the adhesive at elevated temperature and under pressure, wherein water evaporates from the adhesive, and wherein the curing of the adhesive results in a product in which the particles, fibres, layers, strands or parts are bound together by the adhesive.

27. Method according to claim 26, characterized in that the particles, fibres, layers, strands or parts are wood based or cellulose based, such as bamboo, straw, reed, hemp, palm, miscanthus, bagasse, molasses or agricultural waste streams.

28. Method according to any one of the preceding claims 26-27, characterized in that, in the product, the ratio by mass of the total amount of particles, fibres, layers, strands or parts to the solid content of the adhesive, is between 99:1 and 92:8, preferably between 98:2 and 95:5.

29. Method according to any one of the preceding claims 26-28, characterized in that the product is a board, for example a wood fiber board (for example an MDF board or an HDF board), a chipboard, an OSB (Oriented Strand Board) board or a plywood board, or a pressed molded part, such as a pallet block.
